(19) United States
(12) Patent Application Publication
(10) Pub. No.: US 2025/0202109 A1
(43) Pub. Date: Jun. 19, 2025

(54) RADIO WAVE CONTROL SYSTEM, CONTROL APPARATUS, RADIO WAVE CONTROL METHOD, AND NON-TRANSITORY COMPUTER READABLE MEDIUM

(71) Applicant: NEC Corporation, Minato-ku, Tokyo (JP)

(72) Inventors: Ryota NIHEI, Tokyo (JP); Junichi FUNADA, Tokyo (JP); Kenji WAKAFUJI, Tokyo (JP); Kohei YOSHIDA, Tokyo (JP)

(73) Assignee: NEC Corporation, Minato-ku, Tokyo (JP)

(21) Appl. No.: 18/846,393

(22) PCT Filed: Mar. 22, 2022
(86) PCT No.: PCT/JP2022/013171

§ 371 Date: Sep. 12, 2024

(51) Int. Cl. H01Q 3/36; H01Q 5/10

(52) U.S. Cl. CPC H01Q 3/36; H01Q 5/10

(57) ABSTRACT

The objective is to provide a radio wave control system, which is capable of performing beamforming of a plurality of signals having different frequencies with a simple configuration. A radio wave control system according to the present disclosure includes a transmission apparatus (10) that transmits a first signal having a first frequency and a second signal having a second frequency, a reflector device (20) that reflects or transmits the first signal and the second signal in periodically disposed antenna elements and perform beamforming of the first signal and the second signal in respectively different directions, and a control apparatus (30) that controls directions in which beamforming of the first signal and the second signal is performed by controlling phases of the first signal and the second signal by electrically controlling the antenna elements.

### TECHNICAL FIELD

The present disclosure relates to a radio wave control system, a control apparatus, a radio wave control method, and a non-transitory computer readable medium.

### BACKGROUND ART

In recent years, communication areas of 5th Generation (5G), which is a wireless communication standard for which a standard has been specified by 3rd Generation Partnership Project (3GPP), have been expanding. In general, 5G uses higher frequency bands than 4th Generation (4G). Therefore, a 5G wireless communication area formed by a base station is narrower than a 4G wireless communication area. As a result, expanding the 5G wireless communication area requires installation of numerous base stations, increasing the burden of the installation cost for the communication service provider. Further, since it is necessary to install numerous base stations, in a case in which multiple communication service providers install base stations separately, installation locations become limited. Therefore, radio access network (RAN) infrastructure sharing in which multiple communication service providers share and use base stations forming the 5G communication area has been studied.

In the RAN infrastructure shared and used by multiple communication service providers, it is possible to form an appropriate communication area for each communication service provider by performing beamforming capable of transmitting radio waves used by the respective communication service providers in different directions.

Patent Literature 1 discloses a configuration of a multibeam antenna in which a plurality of antenna elements are divided into subunits, and the respective subunits transmit radio waves in different directions. The multibeam antenna disclosed in Patent Literature 1 distributes a signal to each subunit by using a divider.

### CITATION LIST

### Patent Literature

Patent Literature 1: International Patent Publication No. WO2017/126522

### SUMMARY OF INVENTION

### Technical Problem

Patent Literature 1 discloses a configuration of a multibeam antenna that transmits a signal of a specific frequency in any direction. Here, in a case in which a plurality of communication service providers share the multibeam antenna, it is necessary to perform beamforming of a plurality of signals having different frequencies for each communication service provider. However, in a case in which beamforming of a plurality of signals having different frequencies is performed in the multibeam antenna disclosed in Patent Literature 1, it is necessary to prepare as many dividers, power amplifiers, and the like as the number of frequencies, and the number of phase shifters also increases depending on the number of frequencies. Therefore, there is a problem that the apparatus becomes complicated.

In light of the above-described problems, it is an object of the present disclosure to provide a radio wave control system, a control apparatus, a radio wave control method, and a non-transitory computer readable medium, which are capable of performing beamforming of a plurality of signals having different frequencies with a simple configuration.

### Solution to Problem

A radio wave control system according to a first aspect of the present disclosure includes transmission means for transmitting a first signal having a first frequency and a second signal having a second frequency, a reflector device configured to reflect or transmit the first signal and the second signal in periodically disposed antenna elements and perform beamforming of the first signal and the second signal in respectively different directions, and control means for controlling directions in which beamforming of the first signal and the second signal is performed by controlling phases of the first signal and the second signal by electrically controlling the antenna elements.

A control apparatus according to a second aspect of the present disclosure includes management means for managing a frequency and a phase adjustment amount of a signal, and control means for extracting a phase adjustment amount of a first signal having a first frequency transmitted from a transmission apparatus to a reflector device from the management means, and controlling a direction in which beamforming of the first signal and a second signal having a second frequency is performed by controlling a phase of the first signal reflected by or transmitted through the reflector device on the basis of the phase adjustment amount.

A radio wave control method according to a third aspect of the present disclosure includes determining phases of a first signal having a first frequency and a second signal having a second frequency that are transmitted from a transmission apparatus to a reflector device, and electrically controlling periodically disposed antenna elements to have the determined phases of the first signal and the second signal such that beamforming of the first signal is performed in a specific direction, and beamforming of the second signal is performed in a direction different from the first signal.

A program according to a fourth aspect of the present disclosure causes a computer to execute determining phases of a first signal having a first frequency and a second signal having a second frequency that are transmitted from a transmission apparatus to a reflector device, and electrically controlling periodically disposed antenna elements to have the determined phases of the first signal and the second signal such that beamforming of the first signal is performed in a specific direction, and beamforming of the second signal is performed in a direction different from the first signal.

### Advantageous Effects of Invention

According to the present disclosure, it is possible to provide a radio wave control system, a control apparatus, a radio wave control method, and a non-transitory computer readable medium, which are capable of performing beamforming of a plurality of signals having different frequencies with a simple configuration.

### BRIEF DESCRIPTION OF DRAWINGS

FIG. 1 is a configuration diagram of a radio wave control system according to a first example embodiment.

FIG. 2 is a flowchart regarding a radio wave control method executed in a control apparatus according to the first example embodiment.

FIG. 3 is a configuration diagram of a transmission apparatus according to the first example embodiment.

FIG. 4 is a configuration diagram of a control apparatus according to the first example embodiment.

FIG. 5 is a configuration diagram of a radio wave control system according to a second example embodiment.

FIG. 6 is a configuration diagram of a radio wave control system according to a third example embodiment.

FIG. 7 is a configuration diagram of a radio wave control system according to a fourth example embodiment.

FIG. 8 is a configuration diagram of a control apparatus and a transmission apparatus according to the example embodiments.

### EXAMPLE EMBODIMENT

### First Example Embodiment

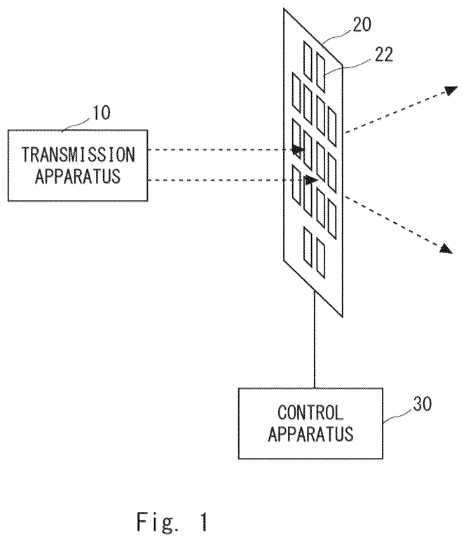

Hereinafter, example embodiments of the present invention will be described with reference to the drawings. A configuration example of a radio wave control system according to a first example embodiment will be described with reference to FIG. 1. The radio wave control system of FIG. 1 includes a transmission apparatus 10, a reflector device 20, and a control apparatus 30. The transmission apparatus 10 and the control apparatus 30 may be computer apparatuses that operate when a processor executes a program stored in a memory.

The transmission apparatus 10 transmits a first signal having a first frequency and a second signal having a second frequency. Specifically, the transmission apparatus 10 transmits the first signal by using a radio wave having the first frequency, and transmits the second signal by using a radio wave having the second frequency. The transmission apparatus 10 is an apparatus used as transmission means for transmitting a signal. The first frequency and the second frequency may be, for example, frequencies included in a range used for mobile communication. The first frequency may be, for example, a center frequency included in a certain frequency band. The second frequency may also be a center frequency included in a certain frequency band. Further, the first frequency and the second frequency may be different center frequencies in the same frequency band. Alternatively, the first frequency may be included in a frequency band different from the frequency band in which the second frequency is included.

Dotted arrows in FIG. 1 indicate signals or radio waves carrying the signals. Although FIG. 1 illustrates that signals or radio waves are linearly transmitted, actually, the signals or the radio waves are incident on the entire reflector device 20 or a partial region of the reflector device 20.

The transmission apparatus 10 may transmit the first signal and the second signal at substantially the same timing, or may transmit the second signal at a timing different from a timing at which the first signal is transmitted.

The reflector device 20 reflects or transmits the first signal and the second signal in periodically disposed antenna elements 22. FIG. 1 illustrates that the reflector device 20 includes a plurality of antenna elements 22. Further, the reflector device 20 performs beamforming of the first signal in a certain direction and performs beamforming of the second signal in a direction different from the first signal.

The reflector device 20 may be, for example, a meta-surface reflector device using a meta-surface technique. For example, the reflector device 20 may be a reconfigurable intelligent surface (RIS) reflector device.

The antenna element 22 is disposed on the surface of the reflector device 20. The antenna element 22 is an element capable of realizing any dielectric constant and magnetic permeability. The antenna element 22 is a structure sufficiently small with respect to the wavelength of the radio wave, and may be, for example, a patch antenna. Furthermore, whether the reflector device 20 operates as a reflector device that reflects the radio waves or operates as a reflector device that transmits the radio waves may be determined depending on a material used for the antenna element 22. Alternatively, whether the reflector device 20 operates as a reflector device that reflects the radio waves or operates as a reflector device that transmits the radio waves may be controlled by overlapping a glass substrate onto the antenna element and adjusting the distance between the glass substrate and the antenna element.

Beamforming is a state in which the radio waves reflected by or transmitted through a plurality of antenna elements 22 overlap each other and the radio waves have directivity in a specific direction. That is, a radio wave having directivity in a specific direction is a state in which a composite wave of radio waves reflected by or transmitted through a plurality of antenna elements 22 forms a beam. The reflector device 20 transmits or reflects the radio wave such that a direction of directivity of the radio wave propagating through the first signal is different from a direction of directivity of the radio wave carrying the second signal.

The control apparatus 30 controls a direction in which the first signal and the second signal are beam-formed by electrically controlling a plurality of antenna elements 22 to control the phases of the first signal and the second signal. Controlling a phase of a signal may mean switching the phase of the signal or switching the phase of the signal.

For example, the control apparatus 30 may switch the phase of the radio wave to be reflected or transmitted by controlling a variable resonance circuit incorporated in the reflector device 20. Alternatively, in a case in which a plurality of materials having different reflection phases is disposed on the surface of the reflector device 20, the control apparatus 30 may switch the phases of the radio waves to be reflected or transmitted by switching and switching a material used as the antenna element 22. Alternatively, a liquid crystal layer may be provided on the surface of the reflector device 20, and the control apparatus 30 may control the dielectric constant by changing the voltage applied to the reflector device 20, thereby switching the phase of the radio wave to be reflected or transmitted. The liquid crystal layer may be disposed for each reflective element.

The control apparatus 30 controls the phase such that the radio wave to be reflected by or transmitted through a plurality of antenna elements 22 becomes a beam having directivity in a specific direction. For example, the control apparatus 30 controls the phase such that the radio wave carrying the first signal becomes a beam having directivity in the first direction. Here, the radio wave of the second frequency carrying the second signal is incident on the reflector device 20, which is controlled such that the radio wave of the first frequency carrying the first signal becomes a beam having directivity in the first direction. At this time, since the radio wave carrying the second signal has a frequency and a phase which are different from those of the radio wave of the first signal, the radio wave is reflected by or transmitted through the reflector device 20 as a beam having directivity in a direction different from the first direction.

In other words, the control apparatus 30 controls the reflector device 20 such that the phase rotation amount of the radio wave of the first frequency to be reflected by or transmitted through the reflector device 20 becomes a specific value. Since the phase rotation amount varies depending on the frequency, the phase rotation amount of the radio wave of the second frequency to be reflected by or transmitted through the reflector device 20 is different from the phase rotation amount of the radio wave of the first frequency. As a result, the radio wave of the second frequency is reflected by or transmitted through the reflector device 20 as the beam having directivity in a direction different from that of the radio wave of the first frequency reflected or transmitted by the reflector device 20.

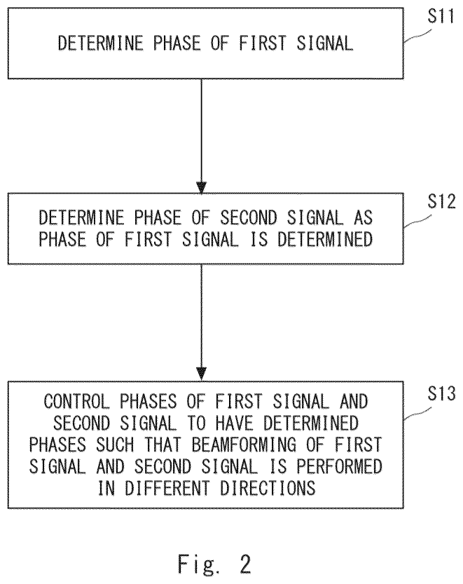

Next, a radio wave control method executed in the control apparatus 30 will be described with reference to FIG. 2. First, the control apparatus 30 determines the phase of the first signal of the first frequency transmitted from the transmission apparatus 10 to the reflector device 20 (S11). Next, as the phase of the first signal is determined, the phase of the second signal is determined (S12). Next, the control apparatus 30 electrically controls the antenna elements 22 periodically disposed on the reflector device 20 such that the first signal and the second signal have the determined phases (S13). As a result, the control apparatus 30 performs beamforming of the first signal in a specific direction and performs beamforming of the second signal in a direction different from the first signal.

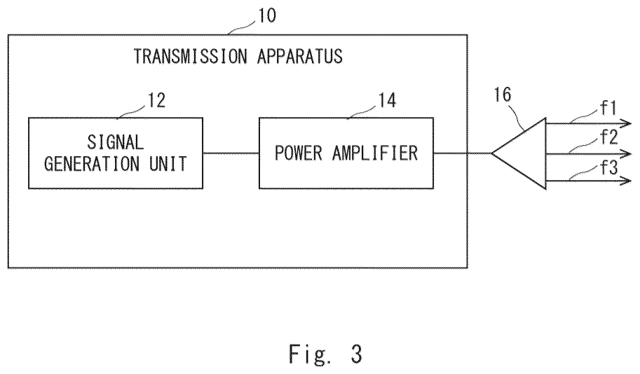

Next, a configuration example of the transmission apparatus 10 will be described with reference to FIG. 3. The transmission apparatus 10 includes a signal generation unit 12, a power amplifier 14, and an antenna 16. The signal generation unit 12 may be a software component or module whose processing is carried out by causing the processor to execute the program stored in the memory. Alternatively, the signal generation unit 12 may be a hardware component such as a circuit or a chip.

For example, the signal generation unit 12 generates a signal obtained by modulating a carrier wave of a specific frequency using transmission data. A carrier wave of a specific frequency may be a carrier wave having a specific center frequency. For example, the signal generation unit 12 generates a plurality of signals having different frequencies by changing the frequency of the carrier wave. The frequency of the carrier wave may be the center frequency of the carrier wave. For example, the signal generation unit 12 may generate a signal for each frequency used by the communication service provider.

The power amplifier 14 may be a broadband power amplifier that amplifies a plurality of signals having different frequencies generated in the signal generation unit 12. As the broadband power amplifier, for example, a traveling wave tube amplifier (TWTA) may be used, or other amplifiers compatible with a wide frequency of several GHz to several tens of GHz may be used.

The antenna 16 transmits the signal amplified by the power amplifier 14. The signal transmitted from the antenna 16 is reflected by or transmitted through the reflector device 20. The antenna 16 is an antenna that transmits a plurality of signals having different frequencies amplified by the power amplifier 14. As the antenna 16, different antenna elements may be used for respective frequencies, or antenna elements capable of transmitting a plurality of signals having different frequencies may be used. FIG. 3 illustrates that signals of a frequency f1, a frequency f2, and a frequency f3 are transmitted from the antenna 16. The signals of the frequency f1, the frequency f2, and the frequency f3 may be signals having the center frequencies f1, f2, and f3.

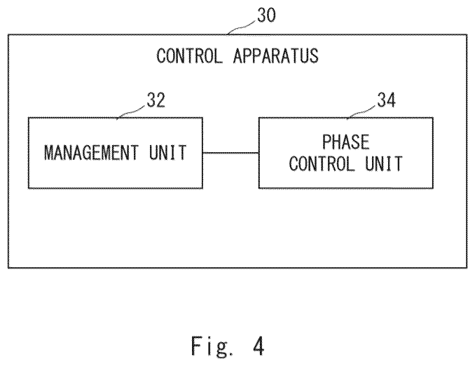

Next, a configuration example of the control apparatus 30 will be described with reference to FIG. 4. The control apparatus 30 includes a management unit 32 and a phase control unit 34. The management unit 32 and the phase control unit 34 may be software components or modules whose processing is carried out by causing the processor to execute the program stored in the memory. Alternatively, the management unit 32 and the phase control unit 34 may be hardware such as a circuit or a chip.

The management unit 32 manages information related to a phase adjustment amount. The phase adjustment amount may be, for example, a phase value of the radio wave to be reflected or transmitted. The phase adjustment amount may be managed as, for example, the phase rotation amount. The phase rotation amount may be, for example, an angle between a reflective surface of the reflector device 20 and a direction of the beam formed by the reflected signal or the transmitted signal. The phase adjustment amount may be managed for each frequency. For example, a phase rotation amount RI may be associated with the frequency f1.

The phase control unit 34 controls the antenna elements arranged on the reflector device 20 so as to become the phase adjustment amount extracted from the management unit 32. For example, the phase control unit 34 may determine a voltage value according to the phase adjustment amount. Alternatively, the phase control unit 34 may transmit, to the reflector device 20, a signal for instructing switching to the material of the antenna element which becomes the extracted phase adjustment amount.

Here, the phase rotation amount determined for each frequency will be described. The phase control unit 34 extracts the phase rotation amount R1 associated with the frequency f1 from the management unit 32. In this case, the phase control unit 34 controls the antenna element 22 such that the phase rotation amount of the signal having the frequency f1 incident on the reflector device 20 becomes R1. At this time, when f1=28 [GHz], a wavelength λ1 of the signal having the frequency f1 is calculated as λ1=c/f1. c is the speed of the radio wave, and a speed value of 300,000 kilometers per second is used. In this case, λ1=10.714 [m] is calculated. Here, in a case in which the phase rotation amount R1=45 [deg], when the phase rotation amount R1 is converted into the wavelength, λ1_1=λ1×(45/360)=1.339 [m] is calculated.

Here, in a case in which the phase control unit 34 controls the antenna element 22 such that the phase rotation amount of the signal having the frequency f1 incident on the reflector device 20 becomes R1, the phase rotation amount R2 of the signal having the frequency f2 incident on the reflector device 20 is calculated. The speed of the radio wave is the same for both the signal having the frequency f1 and the signal having the frequency f2. Therefore, similarly to the signal of the frequency f1, the phase rotation amount R2 for the wavelength λ2 is calculated when the signal of the frequency f2 advances by the distance of λ1_1. Here, when the frequency f2=29 [GHz], the wavelength λ2 of the signal having the frequency f2 is calculated as λ2=c/f2=10.345 [m]. The phase rotation amount R2=46.607 [deg] is calculated from the phase rotation amount R2=λ1_1/λ2.

As a result, in a case in which the antenna element 22 is controlled such that the phase rotation amount of the signal having the frequency f1=28 [GHz] incident on the reflector device 20 becomes R1=45 [deg], the phase rotation amount R2 of the signal having the frequency f2 is also automatically determined. Specifically, the phase rotation amount R2 of the signal having the frequency f2=29 [GHz] incident on the reflector device 20 is 46.607 [deg].

That is, beamforming of the signal having the frequency f1=28 [GHz] is performed in the direction of 45 [deg] with respect to the reflector device 20, and beamforming of the signal having the frequency f2=29 [GHz] is performed in the direction of 46.607 [deg] with respect to the reflector device 20.

As described above, the radio wave control system according to the first example embodiment can form a plurality of beams having directivity in different directions by causing the reflector device 20 to transmit or reflect a plurality of signals having different frequencies transmitted from the transmission apparatus 10. In this case, the transmission apparatus 10 is desirably configured to transmit a plurality of signals having different frequencies. Furthermore, as the reflector device 20 is used to form a plurality of beams having directivity in different directions, it is possible to prevent a configuration of the radio wave control system that forms a plurality of beams from becoming complicated.

Further, the power amplifier 14 in the transmission apparatus 10 in the first example embodiment may be replaced with a low noise amplifier (LNA), and the transmission apparatus 10 may be used as a reception apparatus. In this case, the reception apparatus receives a plurality of signals having different frequencies and demodulates the respective signals.

### Second Example Embodiment

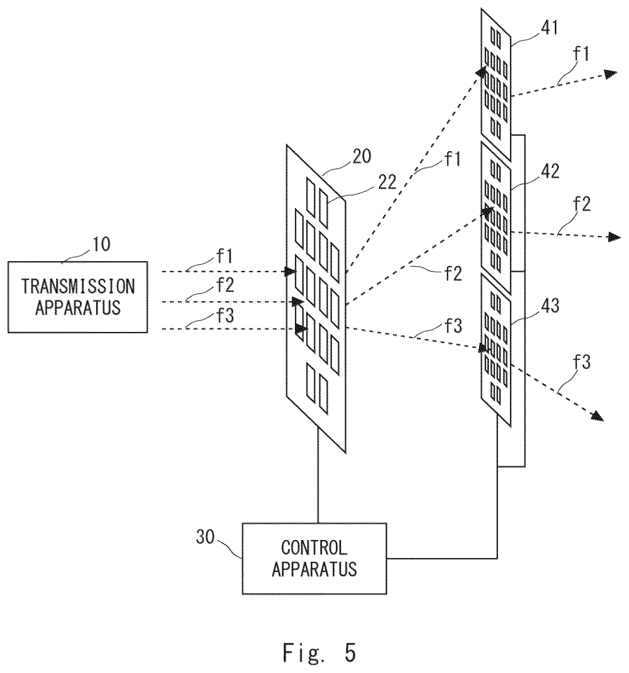

Next, a configuration example of the radio wave control system according to a second example embodiment will be described with reference to FIG. 5. In FIG. 5, a sub-reflector device 41, a sub-reflector device 42, and a sub-reflector device 43 are added to the radio wave control system of FIG. 1. Similarly to the reflector device 20, the antenna elements are periodically disposed in the sub-reflector device 41, the sub-reflector device 42, and the sub-reflector device 43. The control apparatus 30 is connected to the reflector device 20, the sub-reflector device 41, the sub-reflector device 42, and the sub-reflector device 43, and electrically controls the antenna elements disposed in the respective apparatuses.

Here, an example in which the transmission apparatus 10 transmits the signal having the frequency f1 (hereinafter, referred to as an f1 signal), the signal having the frequency f2 (hereinafter, referred to as an f2 signal), and the signal having the frequency f3 (hereinafter, referred to as an f3 signal) will be described. f1, f2, and f3 have different values. That is, the f1 signal, the f2 signal, and the f3 signal are signals having different frequencies.

In a case in which the f1 signal is incident on the reflector device 20, the control apparatus 30 controls a plurality of antenna elements 22 disposed on the reflector device 20 such that the phase rotation amount of the f1 signal transmitted through the reflector device 20 becomes R1. That is, the control apparatus 30 causes the reflector device 20 to perform beamforming of the f1 signal in the direction R1. In a case in which the direction in which beamforming of the f1 signal is performed is determined, the directions in which beamforming of the f2 signal and the f3 signal incident on the reflector device 20 is performed are also determined.

The f1 signal transmitted through the reflector device 20 is incident on the sub-reflector device 41. The f2 signal transmitted through the reflector device 20 is incident on the sub-reflector device 42. The f3 signal transmitted through the reflector device 20 is incident on the sub-reflector device 43. That is, the sub-reflector device 41 is disposed in the traveling direction of the f1 signal, the sub-reflector device 42 is disposed in the traveling direction of the f2 signal, and the sub-reflector device 43 is disposed in the traveling direction of the f3 signal.

In addition, the sub-reflector device 41, the sub-reflector device 42, and the sub-reflector device 43 are disposed at positions where, among the f1 signal, the f2 signal, and the f3 signal, only the f1 signal is incident on the sub-reflector device 41, only the f2 signal is incident on the sub-reflector device 42, and only the f3 signal is incident on the sub-reflector device 43. That is, the sub-reflector device 41, the sub-reflector device 42, and the sub-reflector device 43 are disposed at positions away from the reflector device 20 by a distance L to not overlap each other. For example, it is assumed that the sub-reflector device 41, the sub-reflector device 42, and the sub-reflector device 43 have a square shape with one side of 15 cm or a rectangular shape with a long side of 15 cm. In this case, the sub-reflector device 41, the sub-reflector device 42, and the sub-reflector device 43 need to be disposed at a position, separated from the reflector device 20 by the distance L, where the distance between the respective centers is cm or more. In a case in which the sub-reflector device 41, the sub-reflector device 42, and the sub-reflector device 43 are disposed on the same plane, the distances from the reflector device 20 to the sub-reflector device 41, the sub-reflector device 42, and the sub-reflector device 43 are different, but here, the distances from the reflector device 20 to the sub-reflector devices are regarded as the distance L. The distance from the reflector device 20 to each of the sub-reflector devices is a distance from the reflector device 20 to the center of each of the sub-reflector devices.

For example, in a case in which the phase rotation amount R1 of the f1 signal in the reflector device 20 is 60 [deg], the phase rotation amount R2 of the f2 signal in the reflector device 20 is calculated as 62.143 [deg]. At this time, the distance d between the center points of the sub-reflector device 41 and the sub-reflector device 42 and the distance L satisfy d=L×ΔR. ΔR is expressed as ΔR=(R2−R1)×π/180. When d=0.15 [m], R2=62.143 [deg], and R1=60 [deg], L=4 [m] is obtained. That is, in a case in which control is performed such that the phase rotation amount R1 of the f1 signal becomes 60 [deg], the sub-reflector device 41 and the sub-reflector device 42 each having a square or rectangular shape with one side of 15 cm need to be disposed at a position 4 [m] away from the reflector device 20.

Furthermore, in order to clearly indicate the directivity of each of the f1 signal, the f2 signal, and the f3 signal, each sub-reflector device needs to be disposed in a region where the f1 signal, the f2 signal, and the f3 signal transmitted through the reflector device 20 become far fields. The far field is a distance at which a composite wave of signals transmitted through the antenna. On the other hand, in a case in which the distance element 22 forms a beam. between the reflector device 20 and each of the sub-reflector devices is too short, the peaks of the amplitudes of the respective signals do not sufficiently overlap, hindering beamforming. In a case in which a size D of the reflector device 20 is negligibly small, the distance serving as the far field becomes 2πλ, and the distance serving as the far field increases proportionally to the wavelength λ. On the other hand, in a case in which the size D of the reflector device 20 is not negligible, the distance serving as the far field is 2×D²/λ, and since the size D of the reflector device 20 is fixed, the distance serving as the far field decreases with increasing wavelength. The case in which the size D of the reflector device 20 is not negligible is a case in which the size D of the reflector device 20 is equal to or larger than the wavelength.

The control apparatus 30 controls the phase of the f1 signal to be transmitted through the sub-reflector device 41 by electrically controlling a plurality of antenna elements disposed on the sub-reflector device 41. The control apparatus 30 controls the phase of the f1 signal such that beamforming of the f1 signal is performed in any direction. Further, the control apparatus 30 controls the phase of the f2 signal to be transmitted through the sub-reflector device 42 by electrically controlling a plurality of antenna elements disposed on the sub-reflector device 42. Further, the control apparatus 30 controls the phase of the f3 signal to be transmitted through the sub-reflector device 43 by electrically controlling a plurality of antenna elements disposed on the sub-reflector device 43.

As described above, the control apparatus 30 controls the phase of the signal incident on each sub-reflector device by electrically controlling the sub-reflector device 41, the sub-reflector device 42, and the sub-reflector device 43 in addition to the reflector device 20. In a case in which phase control is performed in the reflector device 20 on which a plurality of signals having different frequencies are incident, the control apparatus 30 performs control such that, for example, beamforming of the f1 signal is performed in a specific direction. At this time, the beamforming directions of the f2 signal and the f3 signal are automatically determined as the beamforming of the f1 signal is determined. Therefore, it is difficult for the control apparatus 30 to set the beamforming direction of a plurality of signals to any direction only by performing phase control in the reflector device 20 on which a plurality of signals having different frequencies are incident.

On the other hand, in the second example embodiment, the sub-reflector device 41 on which the f1 signal is incident, the sub-reflector device 42 on which the f2 signal is incident, and the sub-reflector device 43 on which the f3 signal is incident are disposed at positions away from the reflector device 20. The control apparatus 30 can perform beamforming of the f1 signal, the f2 signal, and the f3 signal in any direction by independently controlling the sub-reflector device 41, the sub-reflector device 42, and the sub-reflector device 43. Furthermore, the control apparatus that controls the reflector device 20 may be an apparatus different from the control apparatus that controls the sub-reflector devices 41 to 43. Furthermore, the sub-reflector devices 41 to 43 may be controlled by a single control apparatus, or may be controlled by different control apparatus. Similarly in other example embodiments, the control apparatus 30 may control the reflector device and the sub-reflector device, and the control apparatus that controls the reflector device may be different from the control apparatus that controls the sub-reflector device. Further, in a case in which there are a plurality of reflector devices, the reflector devices may be controlled by different control apparatuses for respective reflector devices. In addition, even in a case in which there are a plurality of sub-reflector devices, the sub-reflector devices may be controlled by different control apparatus for respective sub-reflector devices.

Further, in the second example embodiment, the reflector device 20 and the sub-reflector devices 41 to 43 are transmissive type reflector devices, but the radio wave control system may be configured by using a reflective type reflector device.

The radio wave control system in FIG. 5 may constitute one base station. In this case, in a case in which it is difficult to install the reflector device 20 and the sub-reflector devices 41 to 43 in the direction horizontal to the ground due to the length of the distance L, the reflector device 20 and the sub-reflector devices 41 to 43 may be installed in the direction vertical to the ground.

### Third Example Embodiment

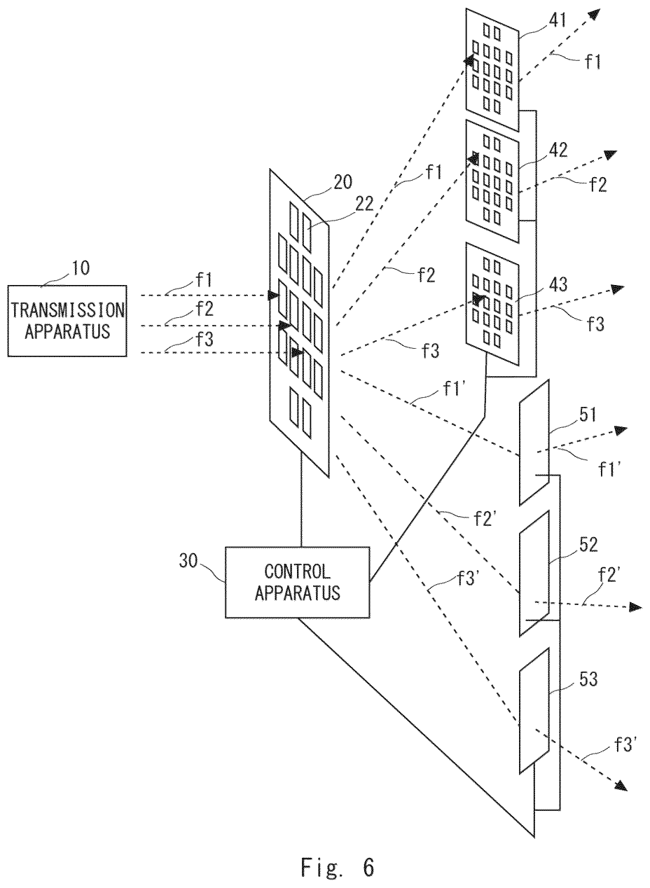

Next, a configuration example of a radio wave control system according to a third example embodiment will be described with reference to FIG. 6. In FIG. 6, a sub-reflector device 51, a sub-reflector device 52, and a sub-reflector device 53 are added to the radio wave control system of FIG. 5. Similarly to the reflector device 20, the antenna elements are periodically disposed in the sub-reflector device 51, the sub-reflector device 52, and the sub-reflector device 53. The control apparatus 30 is connected to the reflector device 20, the sub-reflector device 41, the sub-reflector device 42, the sub-reflector device 43, the sub-reflector device 51, the sub-reflector device 52, and the sub-reflector device 53, and electrically controls the antenna elements disposed in the respective apparatuses.

In FIG. 5, the direction in which beamforming of the f1 signal transmitted through the reflector device 20 is performed is determined, and the directions in which beamforming of the f2 signal and the f3 signal is performed are also determined, and thereafter, beamforming of each signal is fixed.

On the other hand, in FIG. 6, the control apparatus 30 changes the direction in which beamforming of the f1 signal transmitted through the reflector device 20 is performed by electrically controlling the antenna elements disposed on the reflector device 20. In FIG. 6, the f1 signal whose beamforming direction has changed is referred to as an f1′ signal. Further, as the direction in which beamforming of the f1 signal is performed is changed, the directions in which beamforming of the f2 signal and the f3 signal is performed are also changed. The f2 signal and the f3 signal whose beamforming direction has changed are referred to as an f2′ signal and an f3′ signal, respectively.

The f1′ signal is incident on the sub-reflector device 51, the f2′ signal is incident on the sub-reflector device 52, and the f3′ signal is incident on the sub-reflector device 53. In addition, the sub-reflector device 51, the sub-reflector device 52, and the sub-reflector device 53 are disposed at positions where, among the f1′ signal, the f2′ signal, and the f3′ signal, only the f1′ signal is incident on the sub-reflector device 51, only the f2′ signal is incident on the sub-reflector device 52, and only the f3′ signal is incident on the sub-reflector device 53. The relationship of the distance between the reflector device 20 and the sub-reflector devices 51 to 53 is similar to the relationship of the distance between the reflector device 20 and the sub-reflector devices 41 to 43. The positions where the sub-reflector device 51, the sub-reflector device 52, and the sub-reflector device 53 are disposed are determined in a manner similar to the procedure in which the disposition positions of the sub-reflector device 41, the sub-reflector device 42, and the sub-reflector device 43 are determined.

As described above, the radio wave control system in FIG. 6 changes the direction in which beamforming of the signal transmitted through the reflector device 20 is performed. As a result, it is possible to perform beamforming of the signal in a wide range as compared with a case in which the direction in which beamforming of the signal transmitted through the reflector device 20 is performed is fixed.

### Fourth Example Embodiment

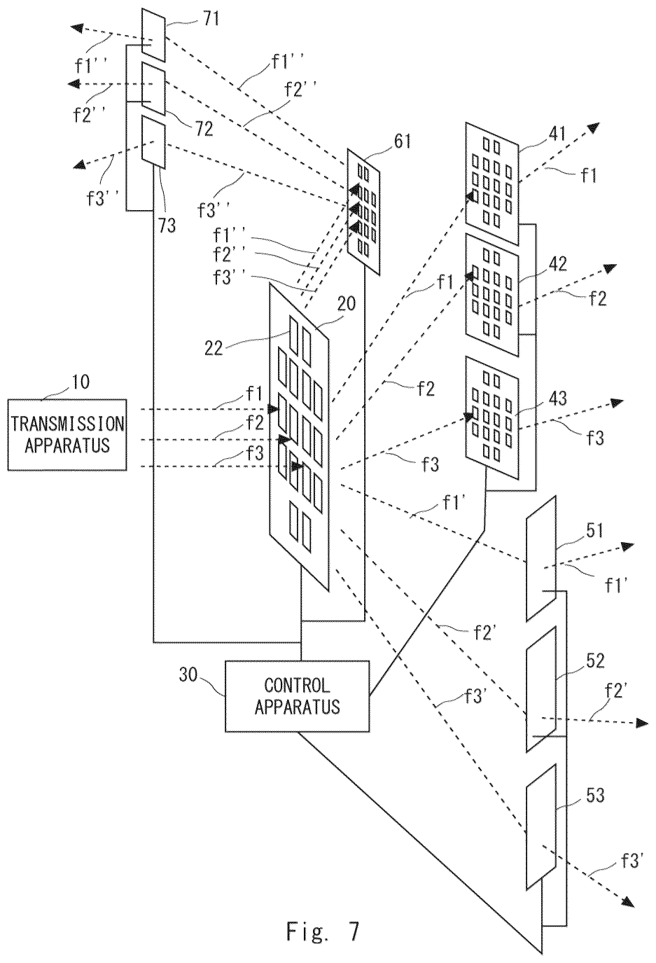

Next, a configuration example of the radio wave control system according to a fourth example embodiment will be described with reference to FIG. 7. In the radio wave control system of FIG. 7, a reflector device 61, a sub-reflector device 71, a sub-reflector device 72, and a sub-reflector device 73 are added to the radio wave control system of FIG. 6. Similarly to the reflector device 20, the antenna elements are periodically disposed in the reflector device 61, the sub-reflector device 71, the sub-reflector device 72, and the sub-reflector device 73. The control apparatus 30 is connected to the reflector device 61, the sub-reflector device 71, the sub-reflector device 72, and the sub-reflector device 73 in addition to the reflector device and the sub-reflector devices illustrated in FIG. 6, and electrically controls the antenna elements disposed in the respective apparatuses.

FIG. 7 illustrates that the control apparatus 30 electrically controls the antenna element arranged on the reflector device 20 such that beamforming of the f1 signal transmitted through the reflector device 20 is performed toward the reflector device 61 in addition to the sub-reflector devices 41 to 43 and the sub-reflector devices 51 to 53. The f1 signal, the f2 signal, and the f3 signal that are beam-formed in the direction of the reflector device 61 are referred to as an f1″ signal, an f2″ signal, and an f3″ signal. The f1″, f2″, and f3″ signals are incident on the reflector device 61. That is, the f1″ signal, the f2″ signal, and the f3″ signal are incident on one reflector device without being incident on different reflector devices. Therefore, the distance between the reflector device 20 and the reflector device 61 may be sufficiently shorter than the distance between the reflector device 20 and the sub-reflector devices 41 to 43. For example, the distance between the reflector device 20 and the reflector device 61 may be a distance in which the interval between the f1″ signal, the f2″ signal, and the f3″ signal in the reflector device 61 falls within one side of the reflector device 61. In other words, in order to increase the difference between the phase rotation amount R1 of the f1″ signal, the phase rotation amount R2 of the f2″ signal, and the phase rotation amount R3 of the f3″ signal, it is not necessary to make significant adjustments to the refraction angles of the f1 signal, the f2 signal, and the f3 signal transmitted through the reflector device 20. In addition, in a case in which the reflector device 20 is a reflective type, it is not necessary to make significant adjustments to the reflection angles of the f1 signal, the f2 signal, and the f3 signal reflected by the reflector device 20.

The reflector device 61 reflects the incident f1″, f2″, and f3″ signals. For example, the control apparatus 30 may electrically control the antenna elements disposed on the reflector device 61 such that the incident f1″ signal is reflected in a particular direction. The specific direction may be, for example, a direction in which the phase rotation amount becomes R11. At this time, the reflection directions of the f2″ signal and the f3″ signal are determined in accordance with the frequencies of the f2″ signal and the f3″ signal. That is, as the control apparatus 30 performs phase control for adjusting the reflection direction of the f1″ signal, the reflection directions of the f2″ signal and the f3″ signal are also determined.

The f1″ signal reflected by the reflector device 61 is incident on the sub-reflector device 71. The f2″ signal reflected by the reflector device 61 is incident on the sub-reflector device 72. The f3″ signal transmitted through the reflector device 61 is incident on the sub-reflector device 73. That is, the sub-reflector device 71 is disposed in the traveling direction of the f1″ signal, the sub-reflector device 72 is disposed in the traveling direction of the f2″ signal, and the sub-reflector device 73 is disposed in the traveling direction of the f3″ signal.

In addition, the sub-reflector device 71, the sub-reflector device 72, and the sub-reflector device 73 are disposed at positions where, among the f1″ signal, the f2″ signal, and the f3″ signal, only the f1″ signal is incident on the sub-reflector device 71, only the f2″ signal is incident on the sub-reflector device 72, and only the f3″ signal is incident on the sub-reflector device 73. The relationship of the distance between the reflector device 61 and the sub-reflector devices 71 to 73 is similar to the relationship of the distance between the reflector device 20 and the sub-reflector devices 41 to 43. The positions where the sub-reflector device 71, the sub-reflector device 72, and the sub-reflector device 73 are disposed are determined in a manner similar to the procedure in which the disposition positions of the sub-reflector device 41, the sub-reflector device 42, and the sub-reflector device 43 are determined.

As described above, the radio wave control system in FIG. 7 can transmit the signals to the periphery of the reflector device 61 by using the reflector device 20. As a result, the communication area in which communication with the transmission apparatus 10 can be performed can be further expanded.

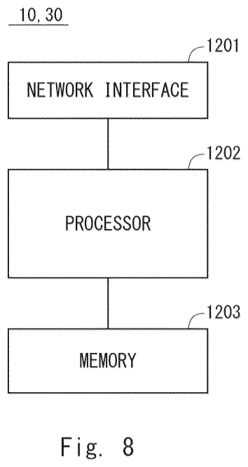

FIG. 8 is a block diagram illustrating a configuration example of the control apparatus 30 and the transmission apparatus 10 (hereinafter, referred to as the control apparatus 30 and the like) described in the above-described example embodiments. Referring to FIG. 8, the control apparatus 30 and the like include a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 performs the processes of the control apparatus 20 and the like described using the flowcharts in the above-described example embodiments, by reading software (computer programs) from the memory 1203 and executing the software. The processor 1202 may be, for example, a microprocessor, a MPU, or a CPU. The processor 1202 may include a plurality of processors.

The memory 1203 is configured with a combination of a volatile memory and a nonvolatile memory. The memory 1203 may include a storage disposed away from the processor 1202. In this case, the processor 1202 may access the memory 1203 through an input/output (I/O) interface (not shown).

In the example in FIG. 8, the memory 1203 is used to store a group of software modules. The processor 1202 can perform the processing of the control apparatus 30 and the like described in the above-described example embodiment by reading and executing these software module groups from the memory 1203.

As described with reference to FIG. 8, each of the processors included in the control apparatus 30 and the like in the above-described example embodiments executes one or a plurality of programs including a command group for causing a computer to perform the algorithm described with reference to the drawings.

In the above-described example, the program includes a group of instructions (or software code) for causing a computer to perform one or more functions described in the example embodiments when being read by the computer. The program may be stored in a non-transitory computer readable medium or a tangible storage medium. As an example and not by way of limitation, a computer readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communications medium. As an example and not by way of limitation, the transitory computer readable medium or the communication medium includes electrical, optical, acoustic, signals, or propagated signals in other forms.

Note that the technological spirits of the present disclosure are not limited to the above-described example embodiments, and can be appropriately modified without departing from the scope.

Some or all of the above-described example embodiments may be described as in the following Supplementary Notes, but are not limited to the following Supplementary Notes.

### (Supplementary Note 1)

A radio wave control system including:
transmission means for transmitting a first signal having a first frequency and a second signal having a second frequency;
a reflector device configured to reflect or transmit the first signal and the second signal in periodically disposed antenna elements and perform beamforming of the first signal and the second signal in respectively different directions; and
control means for controlling directions in which beamforming of the first signal and the second signal is performed by controlling phases of the first signal and the second signal by electrically controlling the antenna elements.

### (Supplementary Note 2)

The radio wave control system according to Supplementary Note 1, further including:
a first sub-reflector device having periodically disposed antenna elements; and
a second sub-reflector device having periodically disposed antenna elements, wherein
the control means
electrically controls the antenna elements of the first sub-reflector device such that beamforming of the first signal transmitted through the reflector device is performed in a specific direction, and
electrically controls the antenna elements of the second sub-reflector device such that beamforming of the second signal transmitted through the reflector device is performed in a direction different from the first signal beam-formed in the first sub-reflector device.

### (Supplementary Note 3)

The radio wave control system according to Supplementary Note 2, wherein
the first sub-reflector device is disposed at a position, not overlapping with the second sub-reflector device, where the first signal out of the first signal and the second signal is incident, and
the second sub-reflector device is disposed at a position, not overlapping with the first sub-reflector device, where the second signal out of the first signal and the second signal is incident.

### (Supplementary Note 4)

The radio wave control system according to Supplementary Note 2 or 3, further including:
a third sub-reflector device having periodically disposed antenna elements; and
a fourth sub-reflector device having periodically disposed antenna elements, wherein
the control means
electrically controls the antenna elements of the third sub-reflector device such that beamforming of the first signal transmitted through the reflector device is performed in a specific direction, and
electrically controls the antenna elements of the fourth sub-reflector device such that beamforming of the second signal transmitted through the reflector device is performed in a direction different from the first signal beam-formed in the third sub-reflector device.

### (Supplementary Note 5)

The radio wave control system according to Supplementary Note 4, wherein
the control means
causes, at a first timing, beamforming of the first signal to be performed in a direction in which the first sub-reflector device is disposed and beamforming of the second signal to be performed in a direction in which the second sub-reflector device is disposed, and
causes, at a second timing, beamforming of the first signal to be performed in a direction in which the third sub-reflector device is disposed and beamforming of the second signal to be performed in a direction in which the fourth sub-reflector device is disposed.

### (Supplementary Note 6)

The radio wave control system according to Supplementary Note 4 or 5, wherein
the third sub-reflector device is disposed at a position, not overlapping with the fourth sub-reflector device, where the first signal out of the first signal and the second signal is incident, and
the fourth sub-reflector device is disposed at a position, not overlapping with the third sub-reflector device, where the second signal out of the first signal and the second signal is incident.

### (Supplementary Note 7)

The radio wave control system according to any one of Supplementary Notes 2 to 6, further including:
a fifth sub-reflector device having periodically disposed antenna elements;
a sixth sub-reflector device having periodically disposed antenna elements; and
a second reflector device that has periodically disposed antenna elements and is disposed at a position where the first signal and the second signal reflected by or transmitted through the reflector device are incident, wherein
the control means
causes beamforming of the first signal transmitted through the second reflector device to be performed in a direction in which the fifth sub-reflector device is disposed, and
causes beamforming of the second signal transmitted through the second reflector device to be performed in a direction in which the sixth sub-reflector device is disposed.

### (Supplementary Note 8)

The radio wave control system according to any one of Supplementary Notes 1 to 7, further including an amplifying means for amplifying the first signal and the second signal.

### (Supplementary Note 9)

A control apparatus including:
management means for managing a frequency and a phase adjustment amount of a signal; and
control means for extracting a phase adjustment amount of a first signal having a first frequency transmitted from a transmission apparatus to a reflector device from the management means, and controlling a direction in which beamforming of the first signal and a second signal having a second frequency is performed by controlling a phase of the first signal reflected by or transmitted through the reflector device on the basis of the phase adjustment amount.

### (Supplementary Note 10)

The control apparatus according to Supplementary Note 9, wherein
the control means
controls the phase of the first signal such that beamforming of the first signal is performed toward a first sub-reflector device having periodically disposed antenna elements, and
controls a phase of the second signal such that beamforming of the second signal is performed toward the second sub-reflector device having periodically disposed antenna elements.

### (Supplementary Note 11)

A radio wave control method executed in a control apparatus, the radio wave control method including:
determining phases of a first signal having a first frequency and a second signal having a second frequency that are transmitted from a transmission apparatus to a reflector device; and
electrically controlling periodically disposed antenna elements to have the determined phases of the first signal and the second signal such that beamforming of the first signal is performed in a specific direction, and beamforming of the second signal is performed in a direction different from the first signal.

### (Supplementary Note 12)

A non-transitory computer readable medium having a program stored therein, the program causing a computer to execute:
determining phases of a first signal having a first frequency and a second signal having a second frequency that are transmitted from a transmission apparatus to a reflector device; and
electrically controlling periodically disposed antenna elements to have the determined phases of the first signal and the second signal such that beamforming of the first signal is performed in a specific direction, and beamforming of the second signal is performed in a direction different from the first signal.

### REFERENCE SIGNS LIST

10 TRANSMISSION APPARATUS
12 SIGNAL GENERATION UNIT
14 POWER AMPLIFIER
16 ANTENNA
20 REFLECTOR DEVICE
22 ANTENNA ELEMENT
30 CONTROL APPARATUS
32 MANAGEMENT UNIT
34 PHASE CONTROL UNIT
41 SUB-REFLECTOR DEVICE
42 SUB-REFLECTOR DEVICE
43 SUB-REFLECTOR DEVICE
51 SUB-REFLECTOR DEVICE
52 SUB-REFLECTOR DEVICE
53 SUB-REFLECTOR DEVICE
61 REFLECTOR DEVICE
71 SUB-REFLECTOR DEVICE
72 SUB-REFLECTOR DEVICE
73 SUB-REFLECTOR DEVICE

What is claimed is:

1. A radio wave control system comprising:
a reflector device configured to reflect or transmit a first signal having a first frequency and a second signal having a second frequency in periodically disposed antenna elements and perform beamforming of the first signal and the second signal in respectively different directions;
at least one memory storing instructions, and
at least one processor configured to execute the instructions to;
transmit the first signal and the second signal; and
control directions in which beamforming of the first signal and the second signal is performed by controlling phases of the first signal and the second signal by electrically controlling the antenna elements.

2. The radio wave control system according to claim 1, further comprising:
a first sub-reflector device having periodically disposed antenna elements; and
a second sub-reflector device having periodically disposed antenna elements, wherein
the at least one processor is further configured to execute the instructions to
electrically control the antenna elements of the first sub-reflector device such that beamforming of the first signal transmitted through the reflector device is performed in a specific direction, and
electrically control the antenna elements of the second sub-reflector device such that beamforming of the second signal transmitted through the reflector device is performed in a direction different from the first signal beam-formed in the first sub-reflector device.

3. The radio wave control system according to claim 2, wherein
the first sub-reflector device is disposed at a position, not overlapping with the second sub-reflector device, where the first signal out of the first signal and the second signal is incident, and
the second sub-reflector device is disposed at a position, not overlapping with the first sub-reflector device, where the second signal out of the first signal and the second signal is incident.

4. The radio wave control system according to claim 2, further comprising:
a third sub-reflector device having periodically disposed antenna elements; and
a fourth sub-reflector device having periodically disposed antenna elements, wherein
the at least one processor is further configured to execute the instructions to
electrically control the antenna elements of the third sub-reflector device such that beamforming of the first signal transmitted through the reflector device is performed in a specific direction, and
electrically control the antenna elements of the fourth sub-reflector device such that beamforming of the second signal transmitted through the reflector device is performed in a direction different from the first signal beam-formed in the third sub-reflector device.

5. The radio wave control system according to claim 4, wherein
the at least one processor is further configured to execute the instructions to
cause, at a first timing, beamforming of the first signal to be performed in a direction in which the first sub-reflector device is disposed and beamforming of the second signal to be performed in a direction in which the second sub-reflector device is disposed, and
cause, at a second timing, beamforming of the first signal to be performed in a direction in which the third sub-reflector device is disposed and beamforming of the second signal to be performed in a direction in which the fourth sub-reflector device is disposed.

6. The radio wave control system according to claim 4, wherein
the third sub-reflector device is disposed at a position, not overlapping with the fourth sub-reflector device, where the first signal out of the first signal and the second signal is incident, and
the fourth sub-reflector device is disposed at a position, not overlapping with the third sub-reflector device, where the second signal out of the first signal and the second signal is incident.

7. The radio wave control system according to claim 2, further comprising:
a fifth sub-reflector device having periodically disposed antenna elements;
a sixth sub-reflector device having periodically disposed antenna elements; and
a second reflector device that has periodically disposed antenna elements and is disposed at a position where the first signal and the second signal reflected by or transmitted through the reflector device are incident, wherein
the at least one processor is further configured to execute the instructions to
cause beamforming of the first signal transmitted through the second reflector device to be performed in a direction in which the fifth sub-reflector device is disposed, and
cause beamforming of the second signal transmitted through the second reflector device to be performed in a direction in which the sixth sub-reflector device is disposed.

8. The radio wave control system according to claim 1, further comprising an amplifying means for amplifying the first signal and the second signal.

9. A control apparatus comprising:
at least one memory storing instructions, and
at least one processor configured to execute the instructions to;
manage a frequency and a phase adjustment amount of a signal; and
extract a phase adjustment amount of a first signal having a first frequency transmitted from a transmission apparatus to a reflector device from the management means, and control a direction in which beamforming of the first signal and a second signal having a second frequency is performed by controlling a phase of the first signal reflected by or transmitted through the reflector device on the basis of the phase adjustment amount.

10. The control apparatus according to claim 9, wherein
the at least one processor is further configured to execute the instructions to
control the phase of the first signal such that beamforming of the first signal is performed toward a first sub-reflector device having periodically disposed antenna elements, and
control a phase of the second signal such that beamforming of the second signal is performed toward the second sub-reflector device having periodically disposed antenna elements.

11. A radio wave control method executed in a control apparatus, the radio wave control method comprising:
determining phases of a first signal having a first frequency and a second signal having a second frequency that are transmitted from a transmission apparatus to a reflector device; and
electrically controlling periodically disposed antenna elements to have the determined phases of the first signal and the second signal such that beamforming of the first signal is performed in a specific direction, and beamforming of the second signal is performed in a direction different from the first signal.

12. (canceled)

13. The radio wave control method according to claim 11, further comprising:
electrically controlling the antenna elements of a first sub-reflector device such that beamforming of the first signal transmitted through the reflector device is performed in a specific direction, the first sub-reflector device having periodically disposed antenna elements, and
electrically control the antenna elements of a second sub-reflector device such that beamforming of the second signal transmitted through the reflector device is performed in a direction different from the first signal beam-formed in the first sub-reflector device, the second sub-reflector device having periodically disposed antenna elements.

14. The radio wave control method according to claim 13, wherein
the first sub-reflector device is disposed at a position, not overlapping with the second sub-reflector device, where the first signal out of the first signal and the second signal is incident, and
the second sub-reflector device is disposed at a position, not overlapping with the first sub-reflector device, where the second signal out of the first signal and the second signal is incident.

15. The radio wave control method according to claim 13, further comprising:
electrically controlling the antenna elements of a third sub-reflector device such that beamforming of the first signal transmitted through the reflector device is performed in a specific direction, the third sub-reflector device having periodically disposed antenna elements, and
electrically controlling the antenna elements of the fourth sub-reflector device such that beamforming of the second signal transmitted through the reflector device is performed in a direction different from the first signal beam-formed in the third sub-reflector device, the fourth sub-reflector device having periodically disposed antenna elements.

16. The radio wave control method according to claim 15, further comprising:
causing, at a first timing, beamforming of the first signal to be performed in a direction in which the first sub-reflector device is disposed and beamforming of the second signal to be performed in a direction in which the second sub-reflector device is disposed, and
causing, at a second timing, beamforming of the first signal to be performed in a direction in which the third sub-reflector device is disposed and beamforming of the second signal to be performed in a direction in which the fourth sub-reflector device is disposed.

17. The radio wave control method according to claim 15, wherein
the third sub-reflector device is disposed at a position, not overlapping with the fourth sub-reflector device, where the first signal out of the first signal and the second signal is incident, and
the fourth sub-reflector device is disposed at a position, not overlapping with the third sub-reflector device, where the second signal out of the first signal and the second signal is incident.

18. The radio wave control method according to claim 13, further comprising:
causing beamforming of the first signal transmitted through a second reflector device to be performed in a direction in which a fifth sub-reflector device is disposed, the second reflector device having periodically disposed antenna elements and being disposed at a position where the first signal and the second signal reflected by or transmitted through the reflector device are incident, the fifth sub-reflector device having periodically disposed antenna elements, and
causing beamforming of the second signal transmitted through the second reflector device to be performed in a direction in which a sixth sub-reflector device is disposed, the sixth sub-reflector device having periodically disposed antenna elements.

19. The radio wave control method according to claim 11, further comprising amplifying the first signal and the second signal.
